(19) United States
(12) Patent Application Publication
(10) Pub. No.: US 2008/0100216 A1
(43) Pub. Date: May 1, 2008

(54) Plasma display panel

(76) Inventor: Joon-Hyeong Kim, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/979,171

(22) Filed: Oct. 31, 2007

(30) Foreign Application Priority Data
Nov. 1, 2006 (KR) 10-2006-0107218

(51) Int. Cl. H01J 17/49

(52) U.S. Cl. 313/582

(57) ABSTRACT

Example embodiments relate to a plasma display panel (PDP), including a front substrate on which an image is to be displayed, a rear substrate facing the front substrate, a plurality of barrier ribs disposed between the front substrate and the rear substrate to partition a plurality of discharge cells, a photoluminescent layer in the discharge cells, discharge electrodes between the front substrate and the rear substrate, and a dielectric layer on the front substrate and covering the discharge electrodes. The front substrate may include a refractive index greater than or equal to a refractive index of the dielectric layer.

### BACKGROUND OF THE INVENTION

1. Field of the Invention

Example embodiments relate to a plasma display panel, and more particularly, to a plasma display panel that may improve brightness and display quality by increasing transmittance of visible light excited from photoluminescent layers formed in discharge cells.

2. Description of the Related Art

In general, a plasma display panel (hereinafter, referred to as PDP) may employ light, e.g., vacuum ultraviolet (VUV) ray, emitted from plasma generated though a gas discharge so as to excite a photoluminescent material, e.g., phosphor. The excited photoluminescent material may generate red (R), green (G), and blue (B) visible light beams, so that an image can be displayed.

The PDP may be manufactured as a large screen display, e.g., greater than 60 inches, and may be reduced to have a thickness of less than 10 cm. Further, because the PDP may be a self emission device (similar to a cathode ray tube (CRT) device), its color reproduction may be excellent, and may not generate any distortion caused by a viewing angle. Further, in comparison to a liquid crystal display (LCD), the manufacturing process of the PDP may be simpler, and thus, increasing productivity and cost competitiveness. Therefore, the PDP may be anticipated as the next generation industrial flat display and home appliance television set.

In a further aspect, the PDP may be divided into a DC type and an AC type according to types of voltage signals for driving each electrode. In the AC type PDP, pairs of electrodes may be disposed on a front substrate to face each other, and address electrodes may be disposed on a rear substrate facing the front substrate with a separation interval. A plurality of discharge cells partitioned by barrier ribs may be arrayed at intersections of the electrodes and the address electrodes between the front substrate and the rear substrate. Inner surfaces of the discharge cells may be coated with a photoluminescent layer, and may be filled with a discharge gas.

The discharge cells may be arranged in a matrix. The discharge cells may be selectively turned on and off by using a memory effect of wall charges, and the selected discharge cells may be discharged, so that visible light may be generated.

The visible light generated from the discharge cells may be transmitted through the front substrate, an upper dielectric layer covering the front substrate, and a protective layer covering the upper dielectric layer, thereby displaying an image.

Further, due to the different materials of the front substrate, the upper dielectric layer and the protective layer, the visible light may endure refraction and reflection at interfaces between the various layers and/or substrates, e.g., the protective layer, the upper dielectric layer, the front substrate, and air. As a result, transmittance of the visible light may deteriorate, resulting in degradation of brightness and display quality.

### SUMMARY OF THE INVENTION

Example embodiments are therefore directed to a display panel, which substantially overcome one or more of the problems due to the limitations and disadvantages of the related art.

It is therefore a feature of example embodiments to improve transmittance of visible light.

It is therefore another feature of example embodiments to increase brightness of the PDP, so as to improve display quality.

At least one of the above and other features of example embodiments may provide a plasma display panel (PDP), including front substrate on which an image is to be displayed, a rear substrate facing the front substrate, a plurality of barrier ribs disposed between the front substrate and the rear substrate to partition a plurality of discharge cells, a photoluminescent layer in the discharge cells, discharge electrodes between the front substrate and the rear substrate, and a dielectric layer on the front substrate and covering the discharge electrodes. The front substrate may include a refractive index greater than or equal to a refractive index of the dielectric layer.

The refractive index of the front substrate may be less than 1.52.

The critical incidence angle at the interface between the front substrate and the air may be greater than 40°.

The refractive index of the dielectric layer may be greater than the refractive index of the air and less than the refractive index of the front substrate.

The PDP may further include a protective layer. The protective layer may cover the dielectric layer.

A refractive index of the protective layer may be less than the refractive index of the dielectric layer.

At least one of the above and other features of example embodiments may provide another PDP, comprising: a front substrate on which an image is to be displayed; a rear substrate facing the front substrate; a plurality of barrier ribs disposed between the front substrate and the rear substrate to partition a plurality of discharge cells; a photoluminescent layer in the discharge cells; discharge electrodes between the front substrate and the rear substrate; a dielectric layer on the front substrate and covering the discharge electrodes; and a protective layer on the dielectric layer, wherein a refraction index of the front substrate, a refraction index of the dielectric layer, and a refraction of the protective layer are adapted to increase transmittance of visible light excited from the phosphor layer.

The front substrate may have a refractive index of less than 1.52.

The critical incidence angle at the interface between the front substrate and the air may be greater than 40°.

The refractive index of the dielectric layer may be greater than the refractive index of the air and less than the refractive index of the front substrate. The PDP may further include a protective layer. The protective layer may cover the dielectric layer. A refractive index of the protective layer may be less than the refractive index of the dielectric layer.

Selectively, the refractive index of the dielectric layer may be equal to the refractive index of the front substrate. The PDP may further include a protective layer. The protective layer may cover the dielectric layer. A refractive index of the protective layer may be less than the refractive index of the dielectric layer.

### BRIEF DESCRIPTION OF THE DRAWINGS

The above and other features and advantages of the example embodiments will become more apparent to those of ordinary skill in the art by describing in detail example embodiments thereof with reference to the attached drawings, in which:

FIG. 1 illustrates a partially exploded perspective view of a plasma display panel according to an example embodiment;

FIG. 2 illustrates a cross-sectional view taken along line II-II of FIG. 1;

FIG. 3 illustrates a view of various optical paths of visible light transmitting through a front substrate;

FIG. 4 illustrates a view of an optical path of visible light incident to a front substrate through a dielectric layer in a plasma display panel according to an example embodiment;

FIG. 5 illustrates a view of an optical path of visible light incident to a front substrate through a dielectric layer in a plasma display panel according to another example embodiment; and

FIG. 6 illustrates a view of an optical path of visible light incident to a front substrate thorough a dielectric layer and a protective layer in a plasma display panel according to another example embodiment.

### DETAILED DESCRIPTION OF THE INVENTION

Korean Patent Application No. 10-2006-0107218, filed on Nov. 1, 2006, in the Korean Intellectual Property Office and entitled: “Plasma Display Panel,” is incorporated by reference herein in its entirety.

Example embodiments will now be described more fully hereinafter with reference to the accompanying drawings; however, example embodiments may be embodied in different forms and should not be construed as limited to the embodiments set forth herein. Rather, these example embodiments are provided so that this disclosure will be thorough and complete, and will fully convey the scope of the invention to those skilled in the art.

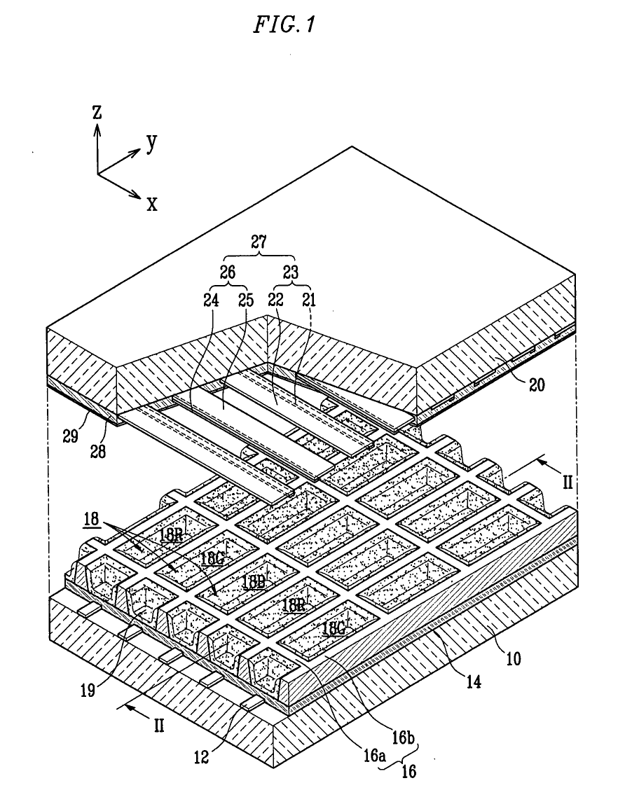

FIG. 1 illustrates a partially exploded perspective view of a plasma display panel (PDP) 1 according to an example embodiment.

Referring to FIG. 1, the PDP 1 may include a first substrate 10 (hereinafter, referred to as a rear substrate), a second substrate 20 (hereinafter, referred to as a front substrate), and barrier ribs 16 disposed in a space between the rear substrate 10 and the front substrate 20 to partition a plurality of discharge cells 18. The rear and front substrates 10 and 20 may be disposed in parallel, and may face each other with a predetermined interval. The rear and front substrates 10 and 20 may be any one of a transparent substrate, e.g., formed of soda lime glass, a semi-transmissible substrate, a reflective substrate, or a colored substrate.

A frit glass (not shown) may be applied to inner surfaces of the rear and front substrates 10 and 20 to be connected therebetween, in order to form a sealed space.

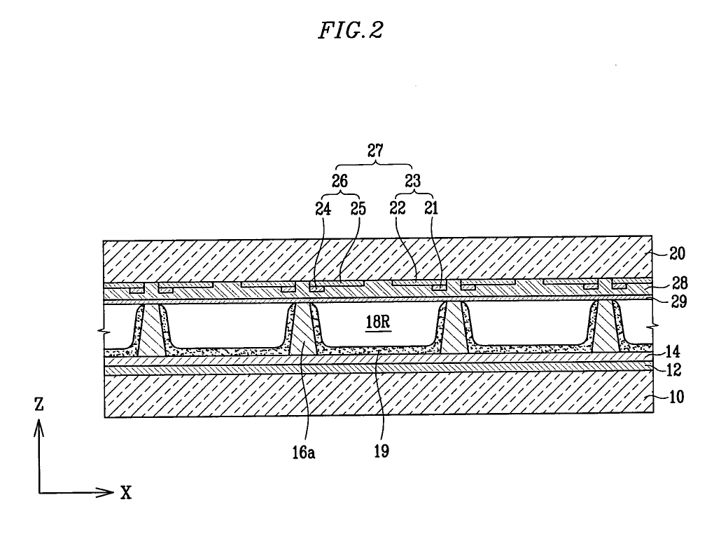

The barrier ribs 16 may be formed by coating a dielectric material 14 (shown in FIG. 2) on the rear substrate 10 via a patterning and sintering process, for example. It should be appreciated that other methods may be employed to form the barrier ribs 16. It should also be appreciated that the barrier ribs 16 may be formed independently from the rear substrate 10.

The barrier ribs 16 may include vertical barrier ribs 16b and horizontal barrier ribs 16a. The vertical barrier ribs 16b may extend along a first direction (e.g., y-direction) and may be arranged apart from each other with a distance therebetween along a second direction (e.g., x-direction). The horizontal barrier ribs 16a may extend along the second direction (e.g., x-direction) and may be arranged apart from each other with a distance therebetewen along the first direction (e.g., y-direction), which may intersect the first direction (e.g., y-direction). Therefore, the discharge cells 18 partitioned by the horizontal and vertical barrier ribs 16a and 16b may be arrayed in a matrix.

It should be appreciated that the discharge cells 18 partitioned by the barrier ribs 16 may be arrayed in other patterns, e.g., a stripe pattern, a delta pattern, or other patterns.

Further, the rear substrate 10 may include address electrodes 12, corresponding to the discharge cells 18, disposed on the surface thereof. Further, because the address electrodes 12 may be disposed on the rear substrate 10, the address electrodes 12 may not obstruct a forward path of visible light. Therefore, the address electrodes 12 may be made of nontransparent materials, e.g., a highly conductive metal, such as silver (Ag). As illustrated in FIG. 1, the address electrodes 12 may extend in the first direction (e.g., y-axis direction).

The front substrate 20 may include a plurality of display electrodes 27 disposed thereon, and may extend in the second direction (e.g., x-direction), intersecting the address electrodes 12.

Photoluminescent layers 19 may be coated on inner surfaces of the discharge cells 18 arrayed in parallel to the display electrodes 27 in the second direction (e.g., x-axis direction). Further, the photoluminescent layers 19 may include a phosphor layer emitting red light 18R, e.g., (Y,Gd)BO₃;Eu⁺³, for example, a phosphor layer emitting green light 18G, e.g., Zn₂SiO₄:Mn²⁺, for example, and/or a phosphor layer emitting blue light 18B, e.g., BaMgAl₁₀O₁₇:Eu²⁺, for example.

The inner surfaces of the discharge cells 18R, 18G, and may be filled with a discharge gas, e.g., neon (Ne), xenon (Xe), helium (He), or a combination thereof, to generate a plasma discharge. In particular, the photoluminescent layers 19 may be disposed on inner surfaces of the discharge cells 17, so that voltage applied to the discharge gas may trigger ultraviolet (UV) light generation, followed by emission of visible light by the photoluminescent layers 19. The photoluminescent layers 19 may be formed on any portion of the inner surface of the discharge cells 17, including an upper surface of the dielectric layer 13 and/or on side surfaces of the barrier ribs 16.

FIG. 2 illustrates a partial cross-sectional view of an assembled PDP 1 of FIG. 1, taken along line II-II of FIG. 1.

Referring to FIG. 2, the lower dielectric layer 14 may be formed on the rear substrate 10 having the address electrodes 12, and may cover the address electrodes 12 so as to prevent damage of the plasma discharge to the address electrodes 12 and to facilitate charge storage. In particular, the lower dielectric layer 14 may reduce and/or prevent cations or electrons from directly colliding with the address electrodes 12, and thus, preventing damage to the address electrodes 12. Further, the lower dielectric layer 14 may facilitate formation and accumulation of wall charges during a discharge. The lower dielectric layer 14 may be formed of a transparent dielectric material, e.g., a mixture of PbO—B₂O₃—SiO₂ having a high electricity.

The display electrodes 27 may be formed with pairs of scan electrode 23 and sustain electrode 26, which may be disposed on the lower surface of the front substrate 20 in parallel to each other in the second direction (e.g., x-direction).

The sustain electrode 26 may function as electrodes for applying a sustain pulse that may be required for a sustain discharge. The scan electrodes 23 may function as electrodes for applying a reset pulse and a scan pulse. The address electrodes 12 may function as electrodes for applying an address pulse.

That is, during a PDP operation, a reset discharge may occur by the reset pulse that may be applied to the scan electrodes 23 for a reset period. For an address period, following the reset period, an address discharge may take place by the scan pulse that may be applied to the scan electrodes 23 and by the address pulse that may be supplied to the address electrodes 12. For a sustain period, a sustain discharge may occur by the sustain pulse that may be applied to the scan and sustain electrodes 23 and 26.

Further, the functions of the sustain electrodes 31, scan electrodes 32 and address electrodes 11 may vary according to a waveform of voltage, that may be applied to each discharge electrodes. It should further be appreciated that the functions may not be limited to the above-described functions.

An upper dielectric layer 28 may be disposed to cover the scan electrodes 23 and the sustain electrodes 26. The upper dielectric layer 28 may be formed of a transparent dielectric material, e.g., a mixture of PbO—B₂O₃—SiO₂ having a high electricity.

A protective layer 29 may be formed on the upper dielectric layer 28 to prevent and/or reduce damage of the plasma discharge to the upper dielectric layer 28. The protective layer 29 may protect the upper dielectric layer 28 and may be made from a magnesium oxide (MgO) material capable of transmitting the visible light and having a high secondary electron emission coefficient. In implementation, a discharge ignition voltage may be lowered.

The scan electrode 23 and the sustain electrode 26 respectively may include bus electrodes 21 and 24, which corresponds to the direction of the horizontal barrier ribs 16a (e.g., x-direction). The scan electrode 23 and the sustain electrode 26 may further include transparent electrodes 22 and 25 extending in the first direction (e.g., y-direction) toward a center of the discharge cell 18. In other words, the transparent electrodes 22 and 25 may extend from edges of the bus electrodes 21 and 24 toward the center along the first direction (e.g., y-direction), and may form a discharge gap in the center of each of the discharge cells 18.

When a voltage signal is applied to the bus electrodes 21 and 24, the voltage signal may be applied to the transparent electrodes 22 and 25, which may be connected to each of the bus electrodes 21 and 24.

The transparent electrodes 22 and 25 may be disposed on the front substrate 20 to extend in the second direction (e.g., x-direction), corresponding to the red, green, and blue discharge cells 18R, 18G, and 18B, respectively. The transparent electrodes 22 and 25 may generate a surface discharge within the discharge cells 17, and may be made of a transparent conductive material, e.g., indium tin oxide (ITO), for ensuring an adequate aperture ratio for the discharge cells 18.

It should further be appreciated that the transparent electrodes 22 and 25 may be formed to extend from the bus electrodes 21 and 24 and to correspond to the red, green, and blue discharge cells 18R, 18G, and 18B, respectively.

The bus electrodes 21 and 24 may be made of highly electrically conductive material, e.g., a non-transparent metal. For example the bus electrodes 21 and 24 may be made of silver (Ag) or a chromium-copper alloy (Cr—Cu—Cr) with high conductivity, so as to compensate for a voltage drop caused by the transparent electrodes 22 and 25. The bus electrodes 21 and 24 may be disposed to be closer to the horizontal barrier ribs 16a interposing the discharge cell 18, so as to increase transmittance of the visible light generated from the discharge cells 18 during the plasma discharge. In addition, the bus electrodes 21 and 24 may be disposed along the horizontal barrier ribs 16a.

In operating the PDP 1, a particular discharge cell 18 may be turned on through a selection of one of the address discharge (i.e., by the address electrodes 12 and a pair of the display electrodes 27). The turned-on discharge cell 18 may then generate the visible light for displaying an image via the sustain discharge.

The visible light generated from the discharge cells 18R, 18G, and 18B may sequentially transmit through the protective layer 29, the upper dielectric layer 28, and the front substrate 20 to form the image.

However, refraction and reflection may occur when the visible light transmits through the protective layer 29, the upper dielectric layer 28, and the front substrate 20, each of which may be constructed with different materials.

In particular, when the visible light having an incidence angle greater than a predetermined angle is incident to the interface of the air and the front substrate 20, the visible light may undergo a total internal reflection. The occurrence of the total internal reflection results in deterioration of forward transmittance of the visible light.

In other words, the total internal reflection may occur at a critical incidence angle θ_{c} when the visible light is incident from a medium having a high refractive index (e.g., the front substrate 20) to a medium having a low refractive index (e.g., air). Thus, the total internal reflection may occur when the incidence angle of the visible light is greater than the critical incidence angle θ_{c}.

Accordingly, example embodiments may provide the critical incidence angle θ_{c}, which may depend on a refractive index n₁ of the front substrate 20, to be increased, so that the transmittance of the visible light may be increased. As a result, brightness and display quality of the PDP 1 may be improved.

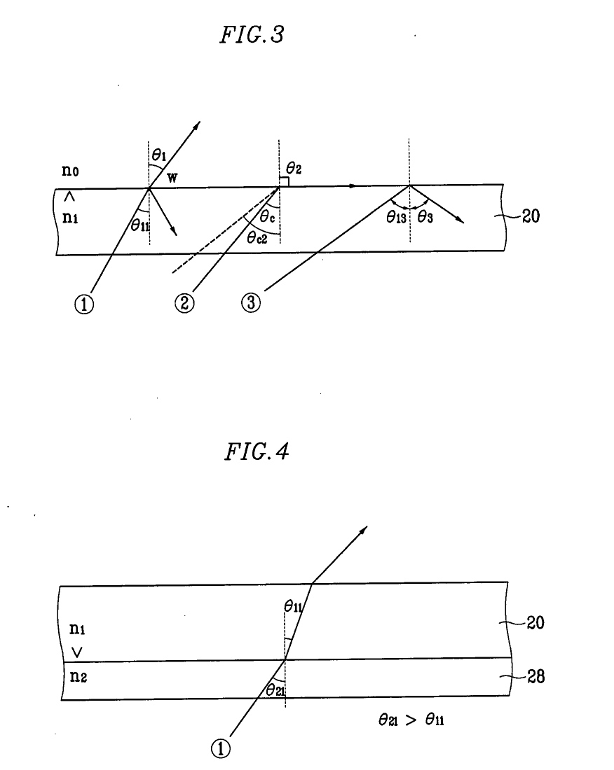

FIG. 3 illustrates a view of various optical paths of visible light transmitting through the front substrate 20.

Referring to FIG. 3, the visible light may be incident to the front substrate 20 with different incidence angles.

In case of visible light \hat{1}, of which an incidence angle θ₁₁ may be less than a critical incidence angle θ_{c}, a portion of the visible light \hat{1} may be reflected at an interface between the front substrate 20 and air, and a remaining portion of the visible light \hat{1} may be refracted with a refraction angle θ₁ greater than the incidence angle θ₁₁ transmitted through the front substrate 20.

In case of visible light \hat{2}, of which an incidence angle θ_{c2} may be equal to the critical incidence angle θ_{c}, a refraction angle θ₂ of the visible light \hat{2} may undergo a total reflection at the interface of the front substrate 20. In this example embodiment, the refraction angle θ₂ may be approximately 90°.

In case of visible light \hat{3}, of which an incidence angle θ₁₃ may be greater than the critical incidence angle θ_{c}, the total reflection may occur at the interface of the front substrate 20. In this example embodiment, the visible light \hat{3}, which may undergo the total reflection, may propagate towards inner surfaces of the discharge cells 18.

Below is an equation for determining the critical incidence angle θ_{c} at the interface between the air and the front substrate 20.

sin 90°/sin θ_{c}=n₁/n₀ ∴ sin θ_{c}=n₀/n₁ (n₁>n₀) [Equation 1]

wherein θ_{c} denotes the critical incidence angle for the front substrate 20, n₀ denotes the refractive index of air, and n₁ denotes the refractive index of the front substrate 20.

As shown in Equation 1, the critical incidence angle θ_{c} at the interface between the air and the front substrate 20 may be determined by a ratio of the refractive index n₁ of the front substrate 20 to the refractive index n₀ of the air.

Further, according to Equation 1, the less the refractive index n₁ of the front substrate 20, the greater the critical incidence angle θ_{c}. Further, the greater the critical incidence angle θ_{c}, the wider a range of incidence angles at which visible light may be transmitted. Accordingly, the transmittance of the visible light may be improved.

In an example embodiment, the refractive index of glass (conventionally used for the front substrate 20) may be approximately 1.52, and the refractive index of air in a standard condition may be approximately 1.00029. Accordingly, the critical incidence angle θ_{c} at the interface between the air and the front substrate 20 may be approximately 40°.

Further, the refractive index n₁ of the front substrate 20 may also be less than the refractive index (1.52) of glass, e.g., 1.52>n₁. In this example embodiment, the critical incidence angle θ_{c2} at the interface between the air and the front substrate 20 may be greater than 40°.

Accordingly, because the critical incidence angle θ_{c2} of the visible light at the interface between the air and the front substrate 20 is large, the forward transmittance of visible light may be increased. Further, it may be possible to avoid a halation effect, e.g., a spreading of the visible light into adjacent discharge cells 18 caused by the total internal reflection, thereby improving display quality.

Although the above example embodiments illustrate the front substrate 20 made of glass material, it should be appreciated that other materials of the front substrate 20 may be employed, as long as visible light may transmit through the materials.

FIG. 4 illustrates a view of an optical path of visible light incident to the front substrate 20 through the upper dielectric layer 28 in the PDP 1 according to another example embodiment.

Referring to FIG. 4, the upper dielectric layer 28 may have a refractive index n₂ less than the refractive index n₁ of the front substrate 20.

As shown in Equation 2 below, the visible light may be incident to the front substrate 20 from the upper dielectric layer 28, in which the refractive index n₂ may be less than the refractive index n₁ of the front substrate 20. Accordingly, a refraction angle θ₁₁ may be less than a incidence angle θ₂₁ of the visible light.

sin θ₁₁=(n₁/n₂)sin θ₂₁ (n₁>n₂) [Equation 2]

whereby θ₂₁ denotes the incidence angle of the visible light, θ₁₁ denotes the refraction angle of the visible light, n₁ denotes the refractive index of the front substrate 20, and n₂ denotes the refractive index of the upper dielectric layer 28.

Accordingly, the visible light may be transmitted through the front substrate 20 in an approximate straight line, thus improving the forward transmittance of the visible light.

Further, the refractive index n₂ of the upper dielectric layer 28 may be greater than the refractive index n₀ of the air and less than the refractive index n₁ of the front substrate 20, e.g., if the refractive index n₁ of the front substrate 20 is less than approximately 1.52, the refractive index n₂ of the upper dielectric layer 28 may be determined to be in a range of approximately 1<n₂<1.52.

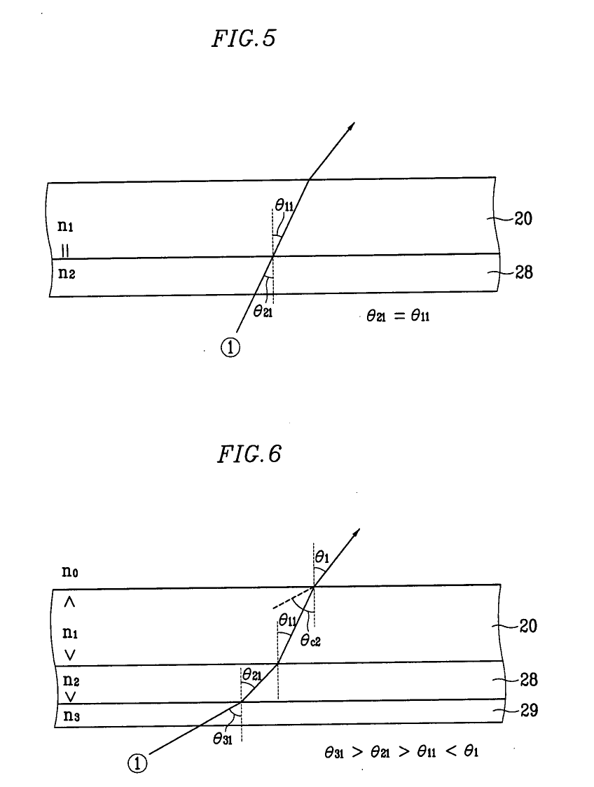

FIG. 5 illustrates a view of an optical path of visible light transmitting towards the front substrate 20 through the upper dielectric layer 28 having the same refractive index as the front substrate 20.

Referring to FIG. 5, the refractive index n₂ of the upper dielectric layer 28 may be equal to the refractive index n₁ of the front substrate 20. Thus, the incidence angle θ₂₁ of the visible light incident to the front substrate 20 through the upper dielectric layer 28 may be equal to the refraction angle θ₁₁.

When the refractive index n2 of the upper dielectric layer 28 is equal to the refractive index n1 of the front substrate 20, the forward transmittance of the visible light may be maintained to be constant.

FIG. 6 illustrates a view of an optical path of visible light incident to the front substrate 20 thorough the dielectric layer 28 and the protective layer 29 in the PDP 1 according to another example embodiment.

Referring to FIG. 6, a refractive index n₃ of the protective layer 29 covering the upper dielectric layer 28 may be less than the refractive index n₂ of the upper dielectric layer 28. Accordingly, the refraction angle θ₂₁ may be less than the incidence angle θ₃₁ of the visible light incident to the protective layer 29. Therefore, the transmittance of the visible light may be increased. However, the present invention is not limited thereto. Thus, the upper dielectric layer may have the same refractive index as the front substrate, as in FIG. 5.

Further, the refractive index n₃ of the protective layer 29 may be less than the refractive index n₁ of the front substrate 20, and the refractive index n₁ of the front substrate 20 may be less than the refractive index (1.52) of a conventional glass.

Accordingly, the refraction angle of the visible light may gradually decrease when the visible light sequentially transmits through the protective layer 29 and the upper dielectric layer 28. As a result, the optical path of the refracted light may be approximately a straight line when the light is incident to the front substrate 20.

Example embodiments provide the critical incidence angle θ_{c2} having a wide range at the interface between the air and the front substrate 20. Thus, a ratio of visible light, which may be transmitted through the front substrate 20 without enduring a total internal refraction, may be increased. As a result, it may improve transmittance of visible light and increase brightness of the PDP to improve display quality.

In the figures, the dimensions of layers and regions may be exaggerated for clarity of illustration. It will also be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Further, it will be understood that when a layer is referred to as being “under” or “above” another layer, it can be directly under or directly above, and one or more intervening layers may also be present. In addition, it will also be understood that when a layer is referred to as being “between” two layers, it can be the only layer between the two layers, or one or more intervening layers may also be present. Like numbers refer to like elements throughout. As used herein, the term “and/or” includes any and all combinations of one or more of the associated listed items.

It will also be understood that, although the terms “first” and “second” etc. may be used herein to describe various elements, structures, components, regions, layers and/or sections, these elements, structures, components, regions, layers and/or sections should not be limited by these terms. These terms are only used to distinguish one element, structure, component, region, layer and/or section from another element, structure, component, region, layer and/or section. Thus, a first element, structure, component, region, layer or section discussed below could be termed a second element, structure, component, region, layer or section without departing from the teachings of example embodiments.

Spatially relative terms, such as “beneath,” “below,” “lower,” “above,” “upper” and the like, may be used herein for ease of description to describe one element or feature relationship to another element(s) or feature(s) as illustrated in the figures. It will be understood that the spatially relative terms are intended to encompass different orientations of the device in use or operation in addition to the orientation depicted in the figures. For example, if the device in the figures is turned over (or upside down), elements or layers described as “below” or “beneath” other elements or layers would then be oriented “above” the other elements or layers. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Example embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the example embodiments as set forth in the following claims.

What is claimed is:

1. A plasma display panel (PDP), comprising:
a front substrate on which an image is to be displayed;
a rear substrate facing the front substrate;
a plurality of barrier ribs disposed between the front substrate and the rear substrate to partition a plurality of discharge cells;
a photoluminescent layer in the discharge cells;
discharge electrodes between the front substrate and the rear substrate; and
a dielectric layer on the front substrate and covering the discharge electrodes,
wherein the front substrate has a refractive index greater than or equal to a refractive index of the dielectric layer.

2. The PDP as claimed in claim 1, wherein the refractive index of the front substrate is less than 1.52.

3. The PDP as claimed in claim 1, wherein the critical incidence angle at the interface between the front substrate and the air is greater than 40°.

4. The PDP as claimed in claim 1, wherein the refractive index of the dielectric layer is greater than the refractive index of the air and less than the refractive index of the front substrate.

5. The PDP as claimed in claim 1, further comprising a protective layer, the protective layer covers the dielectric layer.

6. The PDP as claimed in claim 5, wherein a refractive index of the protective layer is less than the refractive index of the dielectric layer.

7. A plasma display panel (PDP), comprising:
a front substrate on which an image is to be displayed;
a rear substrate facing the front substrate;
a plurality of barrier ribs disposed between the front substrate and the rear substrate to partition a plurality of discharge cells;
a photoluminescent layer in the discharge cells;
discharge electrodes between the front substrate and the rear substrate;
a dielectric layer on the front substrate and covering the discharge electrodes;
and
a protective layer on the dielectric layer,
wherein a refraction index of the front substrate, a refraction index of the dielectric layer, and a refraction of the protective layer are adapted to increase transmittance of visible light excited from the phosphor layer.

8. The PDP as claimed in claim 7, wherein the front substrate has a refractive index of less than 1.52.

9. The PDP as claimed in claim 8, wherein the critical incidence angle at the interface between the front substrate and the air is greater than 40°.

10. The PDP as claimed in claim 8, wherein the refractive index of the dielectric layer is greater than the refractive index of the air and less than the refractive index of the front substrate.

11. The PDP as claimed in claim 10, further comprising a protective layer, the protective layer covers the dielectric layer.

12. The PDP as claimed in claim 11, wherein a refractive index of the protective layer is less than the refractive index of the dielectric layer.

13. The PDP as claimed in claim 10, wherein the refractive index of the dielectric layer is equal to the refractive index of the front substrate.

14. The PDP as claimed in claim 13, further comprising a protective layer, the protective layer covers the dielectric layer.

15. The PDP as claimed in claim 14, wherein a refractive index of the protective layer is less than the refractive index of the dielectric layer.
